(19) United States
(12) Patent Application Publication
(10) Pub. No.: US 2017/0133892 A1
(43) Pub. Date: May 11, 2017

(54) STATOR FOR LOW PROFILE PMSM AND MOTOR HAVING SUCH STATOR

(71) Applicant: FORTIOR TECHNOLOGY (SHEN-ZHEN) CO., LTD, Shenzhen (CN)

(72) Inventor: Lei Bi, Shenzhen (CN)

(21) Appl. No.: 15/409,547

(22) Filed: Jan. 19, 2017

Related U.S. Application Data
(63) Continuation of application No. PCT/CN2014/095491, filed on Dec. 30, 2014.

(51) Int. Cl. H02K 1/14; H02K 1/27

(52) U.S. Cl. CPC H02K 1/146; H02K 1/2786

(57) ABSTRACT

Disclosed is a stator for a low profile Permanent Magnet Synchronous Motor (PMSM), the stator comprising a stator core and a winding wound around the core, wherein the stator core comprises at least one stator lamination, and at least one end of the stator lamination in its axial direction is provided with a folded portion formed from an end face portion being folded up in the thickness direction. In the structure of the stator disclosed by the present disclosure, the space of the stator of the motor can be sufficiently utilized, thus the power density of the motor is increased and the thickness of the motor is reduced. The stacked stator core can reduce the electric loss of the core of the motor.

### CROSS REFERENCE TO RELATED APPLICATIONS

The present application is a Continuation application of PCT application No. PCT/CN2014/095491 filed on Dec. 30, 2014. All the above are hereby incorporated by reference.

### TECHNICAL FIELD

The present disclosure relates to the field of Permanent Magnet Synchronous Motors (PMSMs) having a radial magnetic field, and in particular to a stator for a low profile PMSM and a motor having such a stator

### BACKGROUND

A motor refers to an electrical device for implementing electrical-to-mechanical energy conversion. A Permanent Magnet Synchronous Motor (PMSM) plays an increasingly important role in modern industry and household products due to its high power density and efficiency.

The motor generally adopts a structure with a radial magnetic field, as shown in FIGS. 1 and 2. In FIGS. 1 and 2, illustrated is a basic structure of a PMSM having an external rotor, which includes a rotor yoke, a magnet installed on the rotor, a stator core and an armature winding wound around the stator core; FIG. 3 shows an electrical and magnetic structure of the motor.

The rotor magnet is made of permanent magnetic materials. The rotor yoke is formed by a one-piece steel. In order to reduce iron loss, the stator core is typically formed by stacked soft magnetic iron pieces with high magnetic permeability, such as silicon steel pieces. When the motor rotates, a magnetic field passing through a tooth portion and a yoke portion of the stator core is alternating. The stator core adopting a stacked structure can effectively reduce electric loss, caused by alternating magnetic fields, in the core.

The main factor limiting the thickness of a motor is the structure of its stator, such as the thickness of a stator core and the thickness of an end portion of a coil, as shown in FIG. 3. Iron pieces shown in FIGS. 6 and 7 are stacked to form a stator core shown in FIG. 3. When the thickness of a motor is decreased, the thickness of the stator core must be reduced. Since the magnetic flux passing through an armature winding is related to the interaction area between the stator core and the rotor magnet, a reduction in the thickness of the core decreases the interaction area, and also decreases the capability of the stator core for receiving a magnetic field generated by a permanent magnet of the rotor. In order to ensure that the torque constant of a motor to reach a desired value, a magnetic linkage between a rotor field and the armature winding is required to reach a desired value. Thus, when the thickness of the stator core decreases, the number of turns of the armature winding is required to increase. However, an increase in the number of turns of the armature winding means that the thickness of two end portions of the armature winding is required to increase, see FIGS. 3, 4 and 5. Therefore, for a motor having a radial magnetic field, it is very difficult to reduce the thickness of the motor while ensuring the electromagnetic performance of the motor. It is very difficult to implement a high performance low profile motor.

It is clear that for a low profile motor, the thickness of an end portion of a motor winding is required to be accurately controlled so that there is enough air gap surface between the end portion of the winding and the rotor, so as to prevent the rotor from clashing with the end portion of the winding during rotation of the rotor. But during manufacturing of a winding, it is very difficult to accurately control the thickness of the end portion of the winding, especially in the case that the winding has an increased number of turns. Thus a low yield rate is resulted during manufacturing of low profile motors. And the reliability of motors is poor.

When the thickness of the core is small, the core is very difficult to be secured to a base of the motor due to a very small contact area between the core and the base. This will further result in problems in reliability and yield rate of motors.

Therefore, aiming at the existing technical problems, there is an urgent need for techniques that can provide a high reliability high performance stator for a low profile PMSM and a motor having such a stator.

### SUMMARY

An object of the present disclosure is to avoid the disadvantages of existing techniques, and thus there is provided a high reliability high performance stator for a low profile Permanent Magnet Synchronous Motor (PMSM).

Another object of the present disclosure is to avoid the disadvantages of existing techniques, and thus there is provided a high reliability high performance low profile PMSM having a radial magnetic field.

The object of the present disclosure is implemented through the following technical solutions.

There is provided a stator for a low profile PMSM, the stator including a stator core and a winding wound around the core, wherein the core includes at least one soft magnetic iron piece, and at least one end of the soft magnetic iron piece in its length direction is provided with a folded portion formed from an end face portion being folded up in the thickness direction.

In an embodiment, the folded portion may be arranged to be perpendicular to the length direction of the soft magnetic iron piece.

In an embodiment, the thickness of the folded portion may be 0.1 to 1.5 times the thickness of an end portion of the winding.

In an embodiment, the stator core may include a soft magnetic iron piece and an iron piece, the soft magnetic iron piece and the iron piece are stacked, and at least one end of the soft magnetic iron piece in its length direction is provided with the folded portion that is formed from an end face portion of the soft magnetic iron piece being folded up in the thickness direction away from the iron piece.

In an embodiment, the stator core may include two soft magnetic iron pieces that are stacked, and both ends of the two soft magnetic iron pieces in respective length directions are provided respectively with the folded portion that is formed from an end face portion of each soft magnetic iron piece being folded up in the thickness direction towards outside.

In an embodiment, the stator core may include two soft magnetic iron pieces and at least one layer of iron piece arranged between the two soft magnetic iron pieces, the at least one layer of iron piece and the two soft magnetic iron pieces are stacked, and both ends of the two soft magnetic iron pieces in respective length directions are provided respectively with the folded portion that is formed from an end face portion of each soft magnetic iron piece being folded up in the thickness direction towards outside.

In an embodiment, the folded portion of the soft magnetic iron piece may be shaped by stamping.

Another object of the present disclosure is implemented through the following technical solutions.

There is provided a low profile PMSM having a radial magnetic field, the low profile PMSM including a rotor yoke, a rotor magnet, a motor base and a aforementioned stator, wherein the rotor yoke is secured to the motor base, the rotor magnet is arranged within the rotor yoke, and one end of the stator is secured to the motor base and the other end of the stator is arranged in the rotor yoke.

In an embodiment, a folded portion arranged on one end of the soft magnetic iron piece faces towards the rotor magnet, and a folded portion arranged on the other end of the soft magnetic iron piece is securely connected with the motor base.

The present disclosure has the following beneficial effects.

There is provided a stator for a low profile PMSM, the stator including a core and a winding wound around the core, wherein the core includes at least one soft magnetic iron piece and at least one end of the soft magnetic iron piece in its axial direction is provided with a folded portion formed from an end face portion being folded up in the thickness direction.

In the structure of the stator disclosed by the present disclosure, the space of the stator can be sufficiently utilized, the folded portion having a thickness equivalent to the thickness of the winding is used to increase the interaction area between the stator core and the magnet, in this way, the whole thickness of the core is reduced, thus the power density of the motor is increased and the thickness of the motor is reduced.

The stacked core can reduce the electric loss of the core of the motor, the number of turns of the armature winding can be reduced, thus the thickness of the end portion of the winding is reduced, the resistance of the winding is reduced, and the efficiency of the motor is increased.

The folded portion folded up in the axial direction of the soft magnetic iron piece can protect the end portion of the winding, and a portion of the soft magnetic iron piece facing towards the base of the motor, due to the apparently increased contact face, between the core and the base, resulting from the folded portion of the end face of the core, can conveniently and securely mount the stator core and the winding onto the base of the motor.

A portion of the soft magnetic iron piece folded up near the end face of the rotor yoke can also effectively increase the area of the yoke portion of the stator core, thus the magnetic resistance of the magnetic path of the core is reduced, and electromagnetic performance of the motor is effectively improved. Therefore, the structure of the stator disclosed by the present disclosure can effectively improve reliability of a low profile motor and yield rate during motor manufacturing.

There is provided a low profile PMSM having a radial magnetic field, the low profile PMSM including a rotor yoke, a rotor magnet, a motor base and a aforementioned stator, wherein the stator is arranged in the rotor yoke, the rotor yoke is secured to the motor base, the rotor magnet is arranged within the rotor yoke, and the stator is secured to the motor base.

The low profile low power motor according to the present disclosure can have a thickness of about 5 mm or even thinner. For this motor, there are generally 5 or less iron pieces forming the stator core, adding or reducing one or two iron pieces has a significant impact on the motor, and the thickness of end portion of the winding also has a significant impact on the performance and structure of the motor.

In the prior art, for a super thin motor, a general idea is to reduce the thickness of its stator core. Since the stator core is formed by many 2D stacked iron pieces, a problem thus resulted is that the electrical performance and mechanical performance will be deteriorated, and it is very difficult to wind the winding of the motor, specifically, this is because the 2D core has a very small magnetic section area. In this way, a notch of the core for mounting the winding has to become very small, and the winding has a large number of turns, thus it will be difficult to wind the winding; it is hard to control the thickness of the end portion of the winding, thus a special winding technique must be developed to obtain a winding for a small size super thin motor. In addition, when the thickness of the end portion of the winding increases, the winding is susceptible to damage, thus a low yield rate will be resulted in motor manufacturing, and the reliability of the motor becomes poor.

In the present disclosure, a folded portion formed by an end portion of the soft magnetic iron piece being folded up is used to solve the problem of the super thin motor. In this way, the stator core has a 3D structure, such a transformation in structure leads to many significant changes in the super thin motor: when the thickness of the stator core is reduced, a folded portion on the core being folded facing towards the magnet is formed to increase the interaction area between the stator core and the rotor magnet, a folded portion on the core facing a mount face of the base is formed to increase the contact area between the core and the base, thus electrical performance and mechanical performance of the motor can be sufficiently improved. Therefore, compared to the solution using a conventional structured stator core, it is possible to effectively reduce the thickness of a motor using the 3D stator core according to the present disclosure.

By using the core according to the present disclosure, the number of the winding turns of the motor is reduced, thus it is possible to manufacture a winding by using a conventional winding method. Since the winding is embedded in the stator core, the winding is well protected and thus the reliability of the low profile motor will be improved.

The present disclosure is highly significant for implementing a small size low profile motor. It is possible to implement a high performance motor with the thickness of 5 mm or below.

### BRIEF DESCRIPTION OF THE DRAWINGS

The present invention will be further elaborated with reference to the drawings, which are not to be construed as limiting the scope of the invention.

FIG. 1 is a schematic diagram showing the structure of an existing motor having a radial magnetic field;

FIG. 2 is a schematic diagram showing assembling of an existing motor having a radial magnetic field;

FIG. 3 is a schematic diagram showing the structure an existing stator assembled in a motor;

FIG. 4 is a schematic diagram showing the structure of an existing stator;

FIG. 5 is a section view of an existing stator;

FIG. 6 shows iron pieces forming a stator core of a common low profile stator;

FIG. 7 is a schematic diagram showing, from another angle, iron pieces forming a stator core of a common low profile stator;

FIG. 8 is a schematic diagram showing the structure of a stator core according to a first embodiment of the disclosure;

FIG. 9 is a schematic diagram showing, from another angle, the structure of a stator core according to a first embodiment of the disclosure;

FIG. 10 is a schematic diagram showing the structure of a stator according to a second embodiment of the disclosure;

FIG. 11 is a section view of a stator according to a second embodiment of the disclosure;

FIG. 12 is a schematic diagram showing the structure of a stator assembled in a motor according to a second embodiment of the disclosure;

FIG. 13 is a schematic diagram showing the structure of a stator according to a third embodiment of the disclosure; and

FIG. 14 is a schematic diagram showing the structure of a stator according to a fourth embodiment of the disclosure.

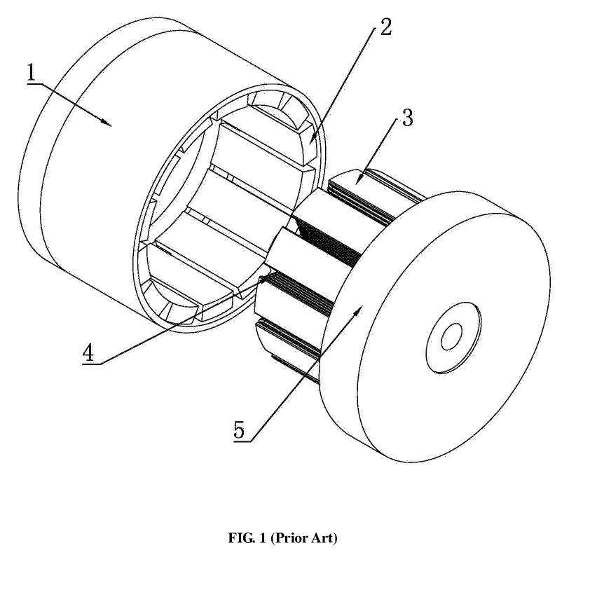

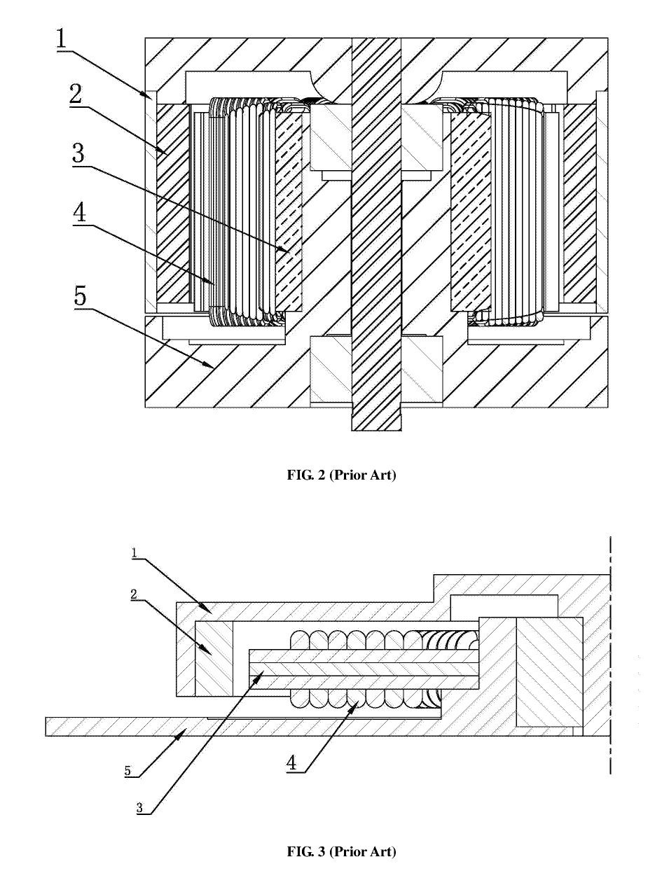

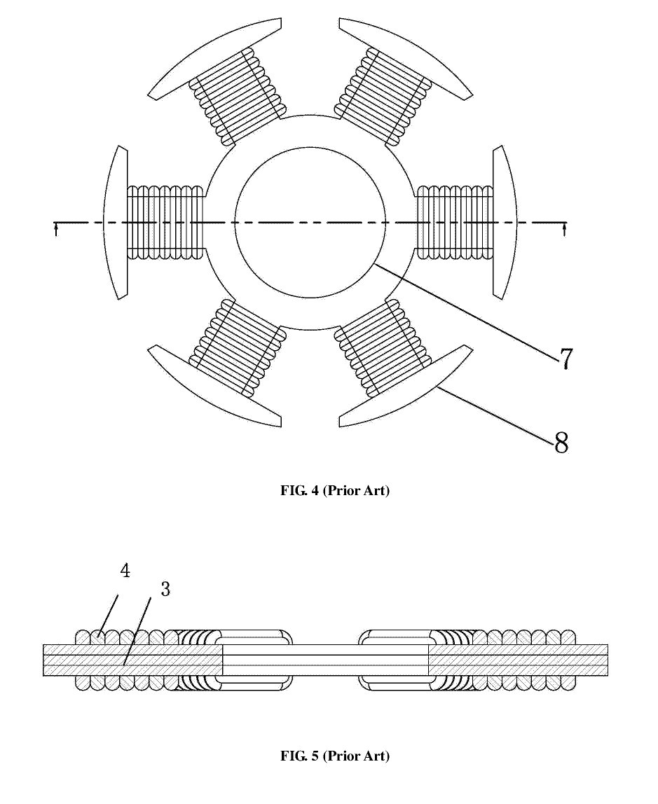

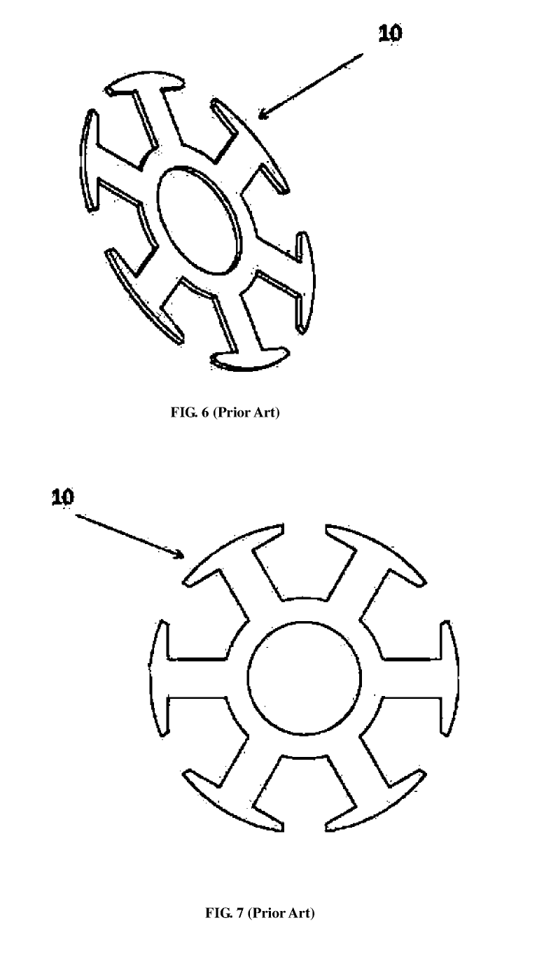

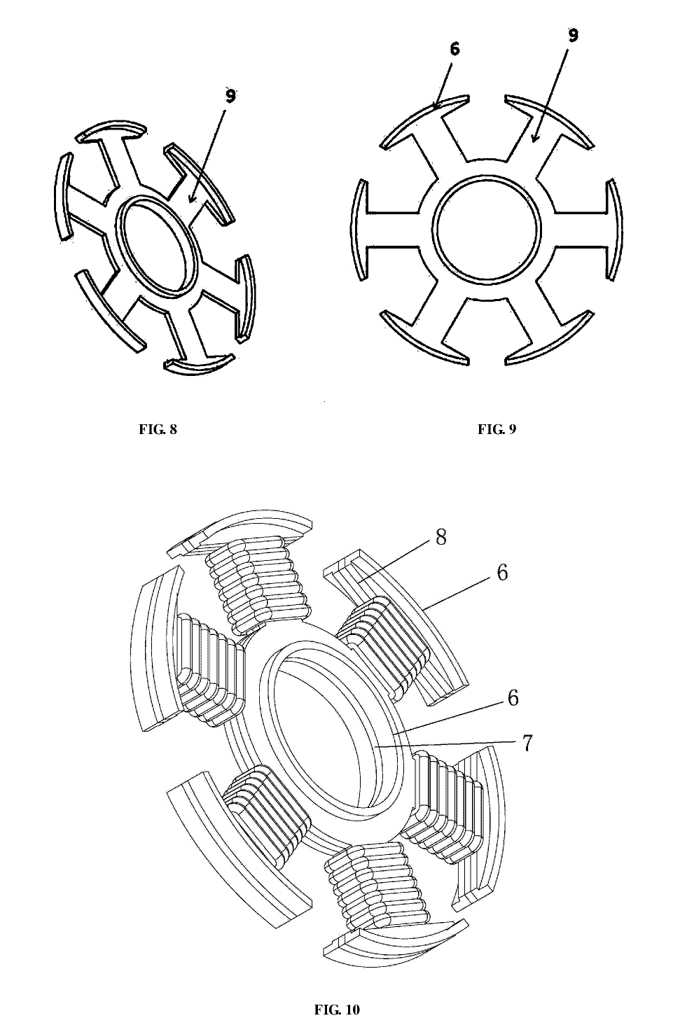

Through FIG. 1 to FIG. 14, reference signs are listed as follows.

1: rotor yoke; 2: rotor magnet; 3: stator core; 4: winding; 5: motor base; 6: folded portion; 7: inner circumference; 8: outer circumference; 9: soft magnetic iron piece; 10: iron piece.

### DETAILED DESCRIPTION

The disclosure will be further described in detail below with reference to embodiments.

### Embodiment 1

As shown in FIGS. 8, 9 and 10, there is provided a low profile Permanent Magnet Synchronous Motor (PMSM) with outer rotor having a radial magnetic field, the low profile PMSM includes a rotor yoke 1, a rotor magnet 2, a motor base 5 and a stator, the magnet 2 is arranged within the rotor yoke 1, the stator core 3 is secured to the motor base 5, the stator includes a stator core and a winding wound around the core 3; the stator core 3 includes at least one soft magnetic iron piece 9, at least one end of the soft magnetic iron piece 9 in its length direction is provided with a folded portion 6 formed from an end face portion being folded up in the thickness direction.

The folded portion 6 is provided on an end face of the soft magnetic iron piece 9 facing the rotor magnet 2, thus the area facing the rotor magnet 2 will increase apparently. Since the body of the stator core 3 is still formed by soft magnetic iron pieces 9 with high magnetic permeability, when the motor rotates, the iron loss of the core 3 of the motor, which is resulted from alternating magnetic field, will be restricted effectively. Using such a core 3, since the linked magnetic flux in the winding 4 increases apparently, the number of turns of the winding 4 can be reduced, and the thickness of the end portion of the winding 4 can also be reduced. All the above are effective to reduce the thickness of the motor. The reduction in the number of turns of the winding 4 will lead to a reduction in the resistance of the winding 4. Therefore, the efficiency of the motor can be improved.

A portion of the soft magnetic iron piece 9 facing the motor base 5 is provided with a folded portion 6, the contact area between the core 3 and the motor base 5 is increased apparently, thus it is possible to conveniently and securely mount the core 3 and the winding 4 onto the motor base 5; in addition, a portion of the soft magnetic iron piece 9 folded up near the end face of the motor base 5 can also effectively increase the area of the yoke portion of the stator core 3, thus the magnetic resistance of the magnetic path of the core 3 is reduced, and electromagnetic performance of the motor is effectively improved.

Specifically, the folded portion 6 may be arranged to be perpendicular to the length direction of the soft magnetic iron piece 9.

Specifically, the thickness of the folded portion may be 0.1 to 1.5 times the thickness of an end portion of the winding 4. The folded portion with such a parameter is easy to be machined with highest efficiency.

The folded portion 6 is shaped by stamping.

The folded portion 6 arranged on one end of the soft magnetic iron piece 9 faces towards the rotor magnet 2, and the folded portion 6 arranged on the other end of the soft magnetic iron piece 9 is securely connected with the motor base 5.

### Embodiment 2

The differences between embodiment 2 and embodiment 1 are as follows.

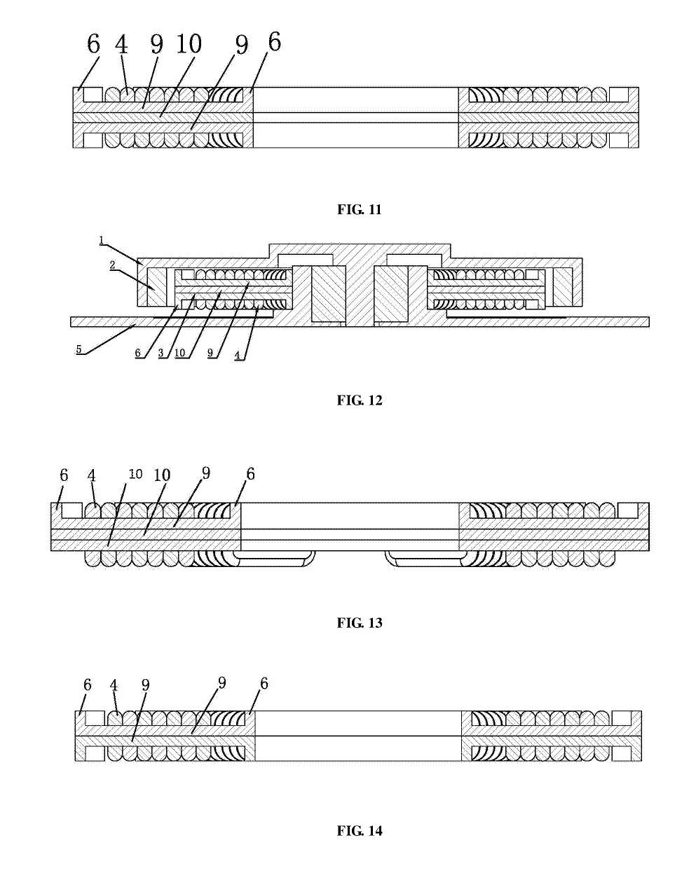

As shown in FIGS. 11 and 12, there is provided a low profile PMSM having a radial magnetic field, the low profile PMSM includes a rotor yoke 1, a rotor magnet 2, a motor base 5 and a stator core 3 is secured to the motor base 5, the rotor magnet 2 is arranged within the rotor yoke 1, the stator core includes two soft magnetic iron pieces 9 and at least one layer of iron piece 10, the at least one layer of iron piece 10 is arranged between the soft magnetic iron pieces 9, the at least one layer of iron piece 10 and the two soft magnetic iron pieces 9 are stacked, and both ends of the two soft magnetic iron pieces 9 in respective length directions are provided respectively with the folded portion 6 that is formed from an end face portion of each soft magnetic iron piece 9 being folded up in the thickness direction towards outside.

The soft magnetic iron pieces 9 and the iron piece 10 are stacked, and both ends of the two soft magnetic iron pieces 9 in respective length directions are provided respectively with the folded portion 6 that is formed from an end face portion of each soft magnetic iron piece 9 being folded up in the thickness direction towards outside.

### Embodiment 3

The differences between embodiment 3 and embodiment 1 are as follows.

There is provided a low profile PMSM having a radial magnetic field, the low profile PMSM includes a rotor yoke 1, a rotor magnet 2, a motor base 5 and a stator core 3, the magnet 2 is arranged within the rotor yoke 1, the stator core 3 is secured to the motor base 5, the core includes a soft magnetic iron pieces 9 and an iron piece 10, the soft magnetic iron piece 9 and the at least one iron piece 10 are stacked, and at least one end of the soft magnetic iron piece 9 in its length direction is provided with a folded portion 6 that is formed from an end face portion of the soft magnetic iron piece 9 being folded up in the thickness direction away from the iron piece 10.

As shown in FIG. 13, in this embodiment, both ends of the soft magnetic iron piece 9 in its length direction are provided with folded portions 6, herein a folded portion 6 arranged on one end faces the rotor magnet 2, and a folded portion 6 arranged on the other end is securely connected to the motor base 5.

The above stator structure can also be evolved to other structures to be adapted to different structures of low profile motors.

### Embodiment 4

The differences between embodiment 4 and embodiment 1 are as follows.

There is provided a low profile PMSM having a radial magnetic field, the low profile PMSM includes a rotor yoke 1, a rotor magnet 2, a motor base 5 and a stator core 3, the magnet 2 is arranged within the rotor yoke 1, the stator core 3 is secured to the motor base 5, the core includes two soft magnetic iron pieces 9 that are stacked, and both ends of the two soft magnetic iron pieces 9 in respective length directions are provided respectively with the folded portion 6 that is formed from an end face portion of each soft magnetic iron piece 9 being folded up in the thickness direction towards outside.

As shown in FIG. 14, both ends of the two soft magnetic iron pieces 9 in respective length directions are provided respectively with the folded portion 6 that is formed from an end face portion of each soft magnetic iron piece 9 being folded up in the thickness direction towards outside.

The motor structures disclosed herein are applicable to single-phase motors, three-phase motors and motors having other number of phases. Although the motors introduced herein are outer-rotor type motors, the structure of the stator core 3 can be easily evolved to those suitable for inner-rotor type motors.

Finally, it is to be noted that the embodiments set forth above are merely illustrative and not meant to be limitations. Although the present application is elaborated with references to the preferred embodiments, those skilled in the art should appreciate that any modification or equivalent substitution may be made to the technical solutions of the present application without departing from the spirit and scope of the invention.

1. A stator for a low profile Permanent Magnet Synchronous Motor (PMSM), the stator comprising a stator core and a winding wound around the core, wherein the stator core comprises at least one stator lamination, and at least one end of the stator lamination in its length direction is provided with a folded portion formed from an end face portion being folded up in the thickness direction.

2. The stator for a low profile PMSM according to claim 1, wherein the folded portion is arranged to be perpendicular to the length direction of the soft magnetic iron piece.

3. The stator for a low profile PMSM according to claim 1, wherein the thickness of the folded portion is 0.1 to 1.5 times the thickness of an end portion of the winding.

4. The stator for a low profile PMSM according to claim 1, wherein the stator lamination comprises a soft magnetic iron piece and an iron piece, the soft magnetic iron piece and the iron piece are stacked, and at least one end of the soft magnetic iron piece in its length direction is provided with the folded portion that is formed from an end face portion of the soft magnetic iron piece being folded up in the thickness direction away from the iron piece.

5. The stator for a low profile PMSM according to claim 1, wherein the stator lamination comprises two soft magnetic iron pieces that are stacked, and both ends of the two soft magnetic iron pieces in respective axial directions are provided respectively with the folded portion that is formed from an end face portion of each soft magnetic iron piece being folded up in the thickness direction towards outside.

6. The stator for a low profile PMSM according to claim 1, wherein the stator lamination comprises two soft magnetic iron pieces and at least one layer of iron piece arranged between the two soft magnetic iron pieces, the at least one layer of iron piece and the two soft magnetic iron pieces are stacked, and both ends of the two soft magnetic iron pieces in respective axial directions are provided respectively with the folded portion that is formed from an end face portion of each soft magnetic iron piece being folded up in the thickness direction towards outside.

7. The stator for a low profile PMSM according to claim 1, wherein the folded portion of the soft magnetic iron piece is shaped by stamping.

8. A low profile Permanent Magnet Synchronous Motor (PMSM) having a radial magnetic field, the low profile PMSM comprising a rotor yoke, a rotor magnet, a motor base and a stator comprising a stator core and a winding wound around the core, wherein the stator core comprises at least one stator lamination, and at least one end of the stator lamination in its length direction is provided with a folded portion formed from an end face portion being folded up in the thickness direction, wherein the rotor yoke is secured to the motor base, the rotor magnet is arranged within the rotor yoke, and one end of the stator is secured to the motor base and the other end of the stator is arranged in the rotor yoke.

9. The low profile PMSM having a radial magnetic field according to claim 8, wherein a folded portion arranged on one end of the stator lamination faces towards the rotor magnet, and a folded portion arranged on the other end of the stator lamination is securely connected with the motor base.

10. The low profile PMSM having a radial magnetic field according to claim 8, wherein the folded portion is arranged to be perpendicular to the length direction of the soft magnetic iron piece.

11. The low profile PMSM having a radial magnetic field according to claim 8, wherein the thickness of the folded portion is 0.1 to 1.5 times the thickness of an end portion of the winding.

12. The low profile PMSM having a radial magnetic field according to claim 8, wherein the stator lamination comprises a soft magnetic iron piece and an iron piece, the soft magnetic iron piece and the iron piece are stacked, and at least one end of the soft magnetic iron piece in its length direction is provided with the folded portion that is formed from an end face portion of the soft magnetic iron piece being folded up in the thickness direction away from the iron piece.

13. The low profile PMSM having a radial magnetic field according to claim 8, wherein the stator lamination comprises two soft magnetic iron pieces that are stacked, and both ends of the two soft magnetic iron pieces in respective axial directions are provided respectively with the folded portion that is formed from an end face portion of each soft magnetic iron piece being folded up in the thickness direction towards outside.

14. The low profile PMSM having a radial magnetic field according to claim 8, wherein the stator lamination comprises two soft magnetic iron pieces and at least one layer of iron piece arranged between the two soft magnetic iron pieces, the at least one layer of iron piece and the two soft magnetic iron pieces are stacked, and both ends of the two soft magnetic iron pieces in respective axial directions are provided respectively with the folded portion that is formed from an end face portion of each soft magnetic iron piece being folded up in the thickness direction towards outside.

15. The low profile PMSM having a radial magnetic field according to claim 8, wherein the folded portion of the soft magnetic iron piece is shaped by stamping.
